(19) United States
(12) Patent Application Publication
(10) Pub. No.: US 2006/0294583 A1
(43) Pub. Date: Dec. 28, 2006

(54) Authenticity Verification

(75) Inventors: Russell Paul Cowburn, London (GB); James David Ralph Buchanan, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Holdings (U.K.) Limited, London (GB)

(21) Appl. No.: 11/382,865

(22) Filed: May 11, 2006

Related U.S. Application Data
(60) Provisional application No. 60/679,892, filed on May 11, 2005.

(51) Int. Cl. H04L 9/32

(52) U.S. Cl. 726/10

(57) ABSTRACT

A method for authenticity verification. The method can comprise conducting a transaction between first and second parties, the parties being respectively located at first and second locations remote one-another, the outcome of the transaction being the provision by the first party to the second party of the right to an entitlement token. Following the transaction outcome, data describing a written format for the entitlement token can be transmitted from the first party to the second party. The entitlement token can be written at the second location using the data describing the written format. The method can further comprise creating a first signature for the written entitlement token at the second location, the signature being based upon an intrinsic property of the written entitlement token, and storing the first signature in a signature database. Further, the method can comprise creating a second signature for the written entitlement token at a third location remote from the second location, the second signature being based upon the intrinsic property of the written entitlement token; and comparing attributes of the second signature with attributes of the first stored in the database to verify the authenticity of the written entitlement token.

### RELATED APPLICATIONS

This application claims the benefit under 35 U.S.C. §119(e) of U.S. provisional application Ser. No. 60/679,892, filed May 11, 2005, entitled “Authenticity Verification”, the contents of which are hereby incorporated herein by reference.

### BACKGROUND OF THE INVENTION

The present invention relates to authenticity verification, and in particular to authenticity verification for situations where entitlement to value, goods or services passes at a location remote in time or space from a delivery point for the value, goods or services.

In many e-commerce and similar situations, transfer of entitlement to value, goods or services is often performed at a location remote from an entity which administers the value or provides the goods or services. Also, a token indicating such entitlement may be issued at a location remote from a location where such entitlement is asserted. It is therefore desirous that such transactions are subjected to a high level of security, to minimise the risks of fraud on the part of both the end user and the service provider or goods supplier.

To address these issues, many issuers of entitlement tokens require a purchaser of a ticket through an online or similar remote access system to pay for the token through the online system, and then ship the token to the purchaser through conventional postal delivery services. Thus the token can be generated using a process which satisfies the anti-fraud requirements of the issuer, at a location and/or using machinery of the issuer's choice. This creates delay between ordering the entitlement token and receiving it for the purchaser (which may also be a source of uncertainty for the purchaser as they pay for the token before receiving it), and requires the purchaser to maintain a facility for creating and shipping ordered entitlement tokens.

Other techniques used to address issues of remote access to entitlement to value, goods or services, include security mechanisms for paying for items in a remote access system such as an on-line access or ordering facility. In these circumstances, a numerical indicator of authority to transfer value from the purchaser to the supplier may be given. Typically this may include a credit or debit card number, and may be supplemented by a numeric PIN (Personal Identification Number) or alphanumeric password. This system does not however offer a guarantee that the purchaser actually has possession of the credit or debit card, although restrictions on a delivery address based on an invoicing address for the credit or debit card may be used as a further safeguard.

### SUMMARY OF THE INVENTION

The present invention has been made, at least in part, in consideration of problems and drawbacks of conventional systems.

The present invention has at least in part resulted from the inventor's work on applying authentication techniques using tokens made of magnetic materials, where the uniqueness is provided by unreproducible defects in the magnetic material that affect the token's magnetic response (as detailed in PCT/GB03/03917, Cowburn). As part of this work, magnetic materials were fabricated in barcode format, i.e. as a number of parallel strips. As well as reading the unique magnetic response of the strips by sweeping a magnetic field with a magnetic reader, an optical scanner was built to read the barcodes by scanning a laser beam over the barcode and using contrast from the varying reflectivity of the barcode strips and the article on which they were formed. This information was complementary to the magnetic characteristic, since the barcode was being used to encode a digital signature of the unique magnetic response in a type of well known self authentication scheme, for example as also described above for banknotes (see for example, Kravolec “Plastic tag makes foolproof ID”, Technology research news, 2 Oct. 2002).

To the surprise of the inventor, it was discovered when using this optical scanner that the paper background material on which the magnetic chips were supported gave a unique optical response to the scanner. On further investigation, it was established that many other unprepared surfaces, such as surfaces of various types of cardboard and plastic, show the same effect. Moreover, it has been established by the inventor that the unique characteristic arises at least in part from speckle, but also includes non-speckle contributions.

It has thus been discovered that it is possible to gain all the advantages of speckle based techniques without having to use a specially prepared token or specially prepare an article in any other way. In particular, many types of paper and cardboard have been found to give unique characteristic scattering signals from a coherent light beam, so that unique digital signatures can be obtained from almost any paper document or cardboard packaging item.

The above-described known speckle readers used for security devices appear to be based on illuminating the whole of a token with a laser beam and imaging a significant solid angle portion of the resultant speckle pattern with a CCD (see for example GB 2 221 870 and U.S. Pat. No. 6,584,214), thereby obtaining a speckle pattern image of the token made up of a large array of data points.

The reader used by the inventor does not operate in this manner. It uses four single channel detectors (four simple phototransistors) which are angularly spaced apart to collect only four signal components from the scattered laser beam. The laser beam is focused to a spot covering only a very small part of the surface. Signal is collected from different localised areas on the surface by the four single channel detectors as the spot is scanned over the surface. The characteristic response from the article is thus made up of independent measurements from a large number (typically hundreds or thousands) of different localised areas on the article surface. Although four phototransistors are used, analysis using only data from a single one of the phototransistors shows that a unique characteristic response can be derived from this single channel alone! However, higher security levels are obtained if further ones of the four channels are included in the response.

Viewed from a first aspect, the present invention provides a method for authenticity verification. The method can comprise conducting a transaction between first and second parties, the parties being respectively located at first and second locations remote one-another, the outcome of the transaction being the provision by the first party to the second party of the right to an entitlement token. Following the transaction outcome, data describing a written format for the entitlement token can be transmitted from the first party to the second party. The entitlement token can be written at the second location using the data describing the written format. The method can further comprise creating a first signature for the written entitlement token at the second location, the signature being based upon an intrinsic property of the written entitlement token, and storing the first signature in a signature database. Further, the method can comprise creating a second signature for the written entitlement token at a third location remote from the second location, the second signature being based upon the intrinsic property of the written entitlement token; and comparing attributes of the second signature with attributes of the first stored in the database to verify the authenticity of the written entitlement token. Thus the authenticity of an entitlement token can be confidently checked to avoid fraudulent copying or tampering of the token without the need for marking the token or other security mechanism.

In one embodiment, the method further comprises creating said first signature using an apparatus integral with an apparatus for writing the entitlement token. Thereby the signature can be created as part of the writing process, such that tampering with the token between writing and signature creation can be avoided.

In some embodiments, the step of creating the first and/or second signature comprises: exposing the written entitlement token to coherent radiation; collecting a set of data points that measure scatter of the coherent radiation from intrinsic structure of the written entitlement token; and determining a signature of the written entitlement token from the set of data points. Thereby a secure and reliable signature generation system with a high confidence margin can be used to provide the authentication.

In some embodiments, the token can be a printed article, where creation of the article includes printing data from an electronic file onto a printing sheet. The printing sheet can be a paper sheet, a cardboard sheet, a plastic sheet or a metal sheet. The printing sheet can have a pattern thereon prior to printing the data.

In some embodiments, the token can be a data storage device, such as a magnetic storage device or an electronic storage device physically associated with a plastic or metal card.

In some embodiments, the article can be an entitlement token or other item which indicates an entitlement to goods or services. Entitlement to the goods or services can be dependent upon a positive verification of authenticity of the article. In some embodiments, the token can be a ticket, a value transfer document, or an access pass.

In some examples, the first location is an e-commerce server such as may be used to host a remote shopping or ordering portal.

Viewed from a second aspect, the present invention provides a system for authenticity verification. The system can comprise first and second computer systems remote one-another and operable to communicate therebetween via a data communications channel, wherein the first computer system is operable to enable to user at the second computer system to conduct a transaction with the first computer system, the outcome of the transaction being the provision by the first computer system to the user of the right to an entitlement token, wherein the first computer system is further operable to transmit data describing the entitlement token to the second computer system via the data communications channel. The system can also comprise a writer co-located with the second computer system and operable to write the entitlement token using the data describing the token, and a first signature generator co-located with the second computer system and operable to create a first signature for the written entitlement token, based upon an intrinsic property of the written entitlement token. The system can also comprise a signature database operable to store the first signature and a second signature generator co-located with a third computer system remote from the second computer system operable to create a second signature for the written entitlement token being based upon the intrinsic property of the written entitlement token. Additionally, the system can comprise a comparator operable to compare attributes of the second signature with attributes of the first signature stored in the database to verify the authenticity of the written entitlement token. Thus the authenticity of an article can be confidently verified without the need for marking the article or implementation of other security mechanism in the article.

In some embodiments, the first and second signature generators comprise: a reading volume arranged to receive an article; a source for generating a coherent light beam; a detector arrangement for collecting a set of data points from signals obtained when the coherent light beam scatters from the reading volume, wherein different ones of the data points relate to scatter from different parts of the reading volume; and a data acquisition and processing module operable to determine a signature of the article from the set of data points. Thus the signatures can be generated with a high confidence in the ability of the system to establish the uniqueness of an item.

In some embodiments, the writer can be co-located with the first signature generator. Thereby, an article can be scanned during or immediately after creation to reduce the possibilities for fraudulent manipulation of the article.

In some embodiments, the token can include a printed pattern on a printing substrate or printing sheet. The printing sheet can be a paper sheet, a cardboard sheet, a plastic sheet or a metal sheet. The printing sheet can have a pattern thereon prior to the token data being written theronto. The printing substrate can be a packaging container or a manufactured article.

In some embodiments, the written entitlement token can comprise a data storage device. The data storage device can be a magnetic storage device or an electronic storage device physically associated with a plastic or metal card.

The entitlement token can indicate entitlement to goods or services. The entitlement to the goods or services can be dependent upon a positive verification of authenticity of the article. The article can be a ticket, a value transfer document, or an access pass.

The third location may be a redemption location for the written entitlement token.

In some embodiments, the system can be used in order to verify authenticity of an article and/or to ascertain whether an article has been tampered with.

Viewed from another aspect, the present invention provides a method for authenticating a ticket, the method comprising: creating a ticket at a location remote from an issue entity therefor; scanning the ticket at the creation location to create a first signature therefor based upon an intrinsic characteristic of the ticket; transmitting the first signature to the issue entity and retaining the first signature or an attribute thereof for subsequent ticket verification; in response to presentation of the ticket for redemption, scanning the ticket to create a second signature therefor based upon the intrinsic characteristic of the ticket; and comparing attributes of the first and second signatures to determine a validity confidence for the ticket. Thereby a ticket can be produced at any location, and scanned to validate the ticket. Thereafter, when the ticket is presented for redemption, the authenticity of the ticket can be verified to determine whether to honour the ticket.

The first signature or an attribute thereof can be stored in a database for the subsequent ticket verification in which an attribute of the first signature is retrieved for comparison by reference to the database. Alternatively, or in addition, the first signature or an attribute thereof can be used by the issue entity to create labelling data that encodes the first signature according to a machine-readable encoding protocol, and the labelling data is transmitted to the second party, and written at the second location onto the entitlement token as a label for the subsequent ticket verification in which an attribute of the first signature is retrieved for comparison by reference to the label.

View from a further aspect, the present invention provides a method for authenticating an access permit, the method comprising: creating a access permit at a location remote from an issue entity therefor; scanning the access permit at the creation location to create a first signature therefor based upon an intrinsic characteristic of the access permit; transmitting the first signature to the issue entity and retaining the first signature or an attribute thereof for subsequent access permit verification; in response to presentation of the access permit for redemption, scanning the access permit to create a second signature therefor based upon the intrinsic characteristic of the access permit; and comparing attributes of the first and second signatures to determine a validity confidence for the access permit.

Thereby an access permit, such as a boarding pass for airline or sea travel can be printed at any location and validated by scanning to create a signature. Thereafter, when the pass is presented for access to a place, event, means of travel etc., the authenticity of the pass can be verified to determine whether to provide the access purported to be provided by the pass.

In some embodiments, it is ensured that different ones of the data gathered in relation to the intrinsic property of the article relate to scatter from different parts of the article by providing for movement of the coherent beam relative to the article. The movement may be provided by a motor that moves the beam over an article that is held fixed. The motor could be a servo motor, free running motor, stepper motor or any suitable motor type. Alternatively, the drive could be manual in a low cost reader. For example, the operator could scan the beam over the article by moving a carriage on which the article is mounted across a static beam. The coherent beam cross-section will usually be at least one order of magnitude (preferably at least two) smaller than the projection of the article so that a significant number of independent data points can be collected. A focusing arrangement may be provided for bringing the coherent beam into focus in the article. The focusing arrangement may be configured to bring the coherent beam to an elongate focus, in which case the drive is preferably configured to move the coherent beam over the article in a direction transverse to the major axis of the elongate focus. An elongate focus can conveniently be provided with a cylindrical lens, or equivalent mirror arrangement.

In other embodiments, it can be ensured that different ones of the data points relate to scatter from different parts of the article, in that the detector arrangement includes a plurality of detector channels arranged and configured to sense scatter from respective different parts of the article. This can be achieved with directional detectors, local collection of signal with optical fibres or other measures. With directional detectors or other localised collection of signal, the coherent beam does not need to be focused. Indeed, the coherent beam could be static and illuminate the whole sampling volume. Directional detectors could be implemented by focusing lenses fused to, or otherwise fixed in relation to, the detector elements. Optical fibres may be used in conjunction with microlenses.

It is possible to make a workable reader when the detector arrangement consists of only a single detector channel. Other embodiments use a detector arrangement that comprises a group of detector elements angularly distributed and operable to collect a group of data points for each different part of the reading volume, preferably a small group of a few detector elements. Security enhancement is provided when the signature incorporates a contribution from a comparison between data points of the same group. This comparison may conveniently involve a cross-correlation.

Although a working reader can be made with only one detector channel, there are preferably at least 2 channels. This allows cross-correlations between the detector signals to be made, which is useful for the signal processing associated with determining the signature. It is envisaged that between 2 and 10 detector channels will be suitable for most applications with 2 to 4 currently being considered as the optimum balance between apparatus simplicity and security.

The detector elements are advantageously arranged to lie in a plane intersecting the reading volume with each member of the pair being angularly distributed in the plane in relation to the coherent beam axis, preferably with one or more detector elements either side of the beam axis. However, non-planar detector arrangements are also acceptable.

The use of cross-correlations of the signals obtained from the different detectors has been found to give valuable data for increasing the security levels and also for allowing the signatures to be more reliably reproducible over time. The utility of the cross-correlations is somewhat surprising from a scientific point of view, since speckle patterns are inherently uncorrelated (with the exception of signals from opposed points in the pattern). In other words, for a speckle pattern there will by definition be zero cross-correlation between the signals from the different detectors so long as they are not arranged at equal magnitude angles offset from the excitation location in a common plane intersecting the excitation location. The value of using cross-correlation contributions therefore indicates that an important part of the scatter signal is not speckle. The non-speckle contribution could be viewed as being the result of direct scatter, or a diffuse scattering contribution, from a complex surface, such as paper fibre twists. At present the relative importance of the speckle and non-speckle scatter signal contribution is not clear. However, it is clear from the experiments performed to date that the detectors are not measuring a pure speckle pattern, but a composite signal with speckle and non-speckle components.

Incorporating a cross-correlation component in the signature can also be of benefit for improving security. This is because, even if it is possible using high resolution printing to make an article that reproduces the contrast variations over the surface of the genuine article, this would not be able to match the cross-correlation coefficients obtained by scanning the genuine article.

In the one embodiment, the detector channels are made up of discrete detector components in the form of simple phototransistors. Other simple discrete components could be used such as PIN diodes or photodiodes. Integrated detector components, such as a detector array could also be used, although this would add to the cost and complexity of the device.

From initial experiments which modify the illumination angle of the laser beam on the article to be scanned, it also seems to be preferable in practice that the laser beam is incident approximately normal to the surface being scanned in order to obtain a characteristic that can be repeatedly measured from the same surface with little change, even when the article is degraded between measurements. At least some known readers use oblique incidence (see GB 2 221 870). Once appreciated, this effect seems obvious, but it is clearly not immediately apparent as evidenced by the design of some prior art speckle readers including that of GB 2 221 870 and indeed the first prototype reader built by the inventor. The inventor's first prototype reader with oblique incidence functioned reasonably well in laboratory conditions, but was quite sensitive to degradation of the paper used as the article. For example, rubbing the paper with fingers was sufficient to cause significant differences to appear upon re-measurement. The second prototype reader used normal incidence and has been found to be robust against degradation of paper by routine handling, and also more severe events such as: passing through various types of printer including a laser printer, passing through a photocopier machine, writing on, printing on, deliberate scorching in an oven, and crushing and reflattening.

It can therefore be advantageous to mount the source so as to direct the coherent beam onto the reading volume so that it will strike an article with near normal incidence. By near normal incidence means ±5, 10 or 20 degrees. Alternatively, the beam can be directed to have oblique incidence on the articles. This will usually have a negative influence in the case that the beam is scanned over the article.

It is also noted that in the readers described in the detailed description, the detector arrangement is arranged in reflection to detect radiation back scattered from the reading volume. However, if the article is transparent, the detectors could be arranged in transmission.

A signature generator can be operable to access the database of previously recorded signatures and perform a comparison to establish whether the database contains a match to the signature of an article that has been placed in the reading volume. The database may be part of a mass storage device that forms part of the reader apparatus, or may be at a remote location and accessed by the reader through a telecommunications link. The telecommunications link may take any conventional form, including wireless and fixed links, and may be available over the internet. The data acquisition and processing module may be operable, at least in some operational modes, to allow the signature to be added to the database if no match is found.

When using a database, in addition to storing the signature it may also be useful to associate that signature in the database with other information about the article such as a scanned copy of the document, a photograph of a passport holder, details on the place and time of manufacture of the product, or details on the intended sales destination of vendable goods (e.g. to track grey importation).

The invention allows identification of articles made of a variety of different kinds of materials, such as paper, cardboard and plastic.

By intrinsic structure we mean structure that the article inherently will have by virtue of its manufacture, thereby distinguishing over structure specifically provided for security purposes, such as structure given by tokens or artificial fibres incorporated in the article.

By paper or cardboard we mean any article made from wood pulp or equivalent fibre process. The paper or cardboard may be treated with coatings or impregnations or covered with transparent material, such as cellophane. If long-term stability of the surface is a particular concern, the paper may be treated with an acrylic spray-on transparent coating, for example.

Data points can thus be collected as a function of position of illumination by the coherent beam. This can be achieved either by scanning a localised coherent beam over the article, or by using directional detectors to collect scattered light from different parts of the article, or by a combination of both.

The signature is envisaged to be a digital signature in most applications. Typical sizes of the digital signature with current technology would be in the range 200 bits to 8 k bits, where currently it is preferable to have a digital signature size of about 2 k bits for high security.

A further implementation of the invention can be performed without storing the digital signatures in a database, but rather by labelling the entitlement token with a label derived from the signature, wherein the label conforms to a machine-readable encoding protocol.

More specifically, a further aspect of the invention provides a method for authenticity verification, the method comprising: conducting a transaction between first and second parties, the parties being respectively located at first and second locations remote one-another, the outcome of the transaction being the provision by the first party to the second party of the right to an entitlement token; transmitting data describing a written format for the entitlement token from the first party to the second party; writing the entitlement token using the data describing the written format at the second location; creating a first signature for the written entitlement token at the second location, the first signature being based upon an intrinsic property of the written entitlement token; transmitting the first signature to the first party; and retaining the first signature or an attribute thereof for subsequent authenticity verification of the written entitlement token, wherein the retaining step comprises the first party processing the first signature to generate labelling data that encodes the first signature according to a machine-readable encoding protocol, transmitting the labelling data to the second party, and writing a label representing the labelling data at the second location onto the entitlement token.

Furthermore, the invention provides a system for authenticity verification, the system comprising: first and second computer systems remote one-another and operable to communicate therebetween via a data communications channel, wherein the first computer system is operable to enable to user at the second computer system to conduct a transaction with the first computer system, the outcome of the transaction being the provision by the first computer system to the user of the right to an entitlement token, wherein the first computer system is further operable to transmit data describing the entitlement token to the second computer system via the data communications channel; a writer co-located with the second computer system and operable to write the entitlement token using the data describing the token; and a first signature generator co-located with the second computer system and operable to create a first signature for the written entitlement token, based upon an intrinsic property of the written entitlement token, and to transmit the first signature to the first party, wherein the first computer system is operable to process the first signature to generate labelling data that encodes the first signature according to a machine-readable encoding protocol, and to transmit the labelling data to the second party, and wherein the writer is operable to write a label representing the labelling data onto the entitlement token.

The first signature is preferably encoded in the label using an asymmetric encryption algorithm. The label may represents a public key in a public key/private key encryption system. Conveniently, e.g. for electronic ticketing, the label can be an ink label applied to the entitlement token with a printing process.

In this group of embodiments, the data acquisition and processing module is operable to further analyse the data points to identify a signal component that follows a predetermined encoding protocol and to generate a reference signature therefrom. The characteristic of the predetermined encoding protocol is envisaged to be based on contrast, i.e. scatter signal strength, in most embodiments. In particular, a conventional bar code protocol may be used in which the bar code is printed or otherwise applied to the article in the form of stripes in the case of a ID barcode or more complex patterns for a 2D bar code, e.g. a high density barcode such as according to pdf417. In this case, the data acquisition and processing module can be operable to perform a comparison to establish whether the first (reference) signature matches the second signature obtained by reading an article that has been placed in the reading volume. Consequently, an article such as a paper ticket can be marked to bear a digitally signed version of its own characteristic, such as a barcode. The reference signature should be obtained from the article's characteristic with a one-way function, i.e. using an asymmetric encryption algorithm that requires a private key known only to the issuing entity. This acts as a barrier to an unauthorised third party with a reader, who wants to create forged articles by scanning forged articles to obtain the first signature and then printing on the forged article a label that represents the reader's scan according to the encryption scheme. Typically the bar code label or other mark would represent a cryptogram decipherable by a public key, and the private key would be reserved for the authorised issuing entity party.

When using a database, in addition to storing the signature it may also be useful to associate that signature in the database with other information such as further information about the article such as a scanned copy of the document, a photograph of a passport holder, details on the place and time of manufacture of the product, or details on the intended destination of the article (e.g. the airport of embarkation where an air ticket is to be surrendered), or information on the identity of the second party (e.g. data on the purchaser of a ticket could be retained so that touting of the ticket by resale could be prevented in that the comparison at the third location would include checking that the person in physical possession of the ticket at the time of surrender is the same person as purchased and created the ticket).

### BRIEF DESCRIPTION OF THE FIGURES

Specific embodiments of the present invention will now be described by way of example only with reference to the accompanying figures in which:

FIG. 1 is a schematic side view of an example of a reader apparatus;

FIG. 2 is a schematic perspective view showing how the reading volume of the reader apparatus of FIG. 1 is sampled;

FIG. 3 is a block schematic diagram of the functional components of the reader apparatus of FIG. 1;

FIG. 4 is a perspective view of the reader apparatus of FIG. 1 showing its external form;

FIG. 5 is a perspective view showing another example of an external form for the reader of FIG. 1;

FIG. 6 is a perspective view showing another example of an external form for the reader of FIG. 1;

FIG. 7 is a schematic perspective view of an alternative example of a reader apparatus;

FIG. 8A shows schematically in side view an alternative imaging arrangement for a reader embodying the invention based on directional light collection and blanket illumination;

FIG. 8B shows schematically in plan view the optical footprint of a further alternative imaging arrangement for a reader embodying the invention in which directional detectors are used in combination with localised illumination with an elongate beam;

FIG. 9 is a microscope image of a paper surface with the image covering an area of approximately 0.5×0.2 mm;

FIG. 10A shows raw data from a single photodetector using the reader of FIG. 1 which consists of a photodetector signal and an encoder signal;

FIG. 10B shows the photodetector data of FIG. 8A after linearisation with the encoder signal and averaging the amplitude;

FIG. 10C shows the data of FIG. 8B after digitisation according to the average level;

FIG. 11 is a flow diagram showing how a signature of an article is generated from a scan;

FIG. 12 is a flow diagram showing how a signature of an article obtained from a scan can be verified against a signature database;

FIG. 13 is a schematic overview of a distributed transaction environment such as an e-commerce environment; and

FIG. 14 is a schematic plan view of an electronic ticket bearing a barcode label that encodes a digital signature obtained from an intrinsic measured surface characteristic.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DESCRIPTION OF PARTICULAR EMBODIMENTS

For providing security and authorisation services in environments such as an e-commerce environment, a system for uniquely identifying a physical item can be used to reduce possibilities for fraud, and to enhance both actual and perceived reliability of the e-commerce system, for both provider and end-users.

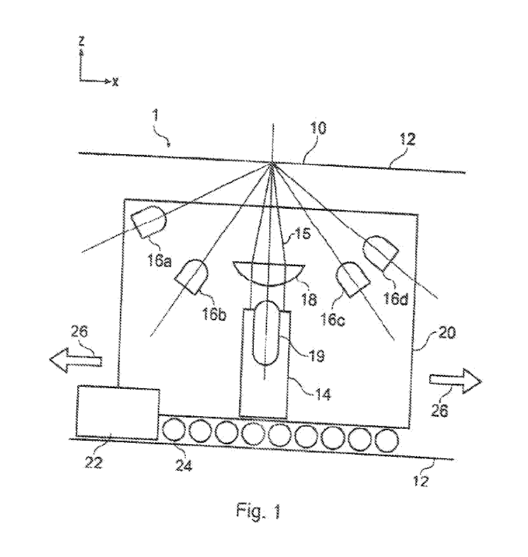

Examples of systems suitable for performing such item identification will now be described with reference to FIGS. 1 to 12.

FIG. 1 shows a schematic side view of a first example of a reader apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=4 in this example, labelled 16a, 16b, 16c and 16d. The laser beam 15 is focused by a cylindrical lens 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly 20. In the present example, the four detector elements 16a . . . d are distributed either side of the beam axis offset at different angles in an interdigitated arrangement from the beam axis to collect light scattered in reflection from an article present in the reading volume. In the present example, the offset angles are −70, −20, +30 and +50 degrees. The angles either side of the beam axis are chosen so as not to be equal so that the data points they collect are as independent as possible. All four detector elements are arranged in a common plane. The photodetector elements 16a . . . d detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In the present example, the depth of focus is approximately 0.5 mm which is sufficiently large to produce good results where the position of the article relative to the scanner can be controlled to some extent. The parameters, of depth of focus, numerical aperture and working distance are interdependent, resulting in a well known trade off between spot size and depth of focus.

A drive motor 22 is arranged in the housing 12 for providing linear motion of the optics subassembly 20 via suitable bearings 24 or other means, as indicated by the arrows 26. The drive motor 22 thus serves to move the coherent beam linearly in the x direction over the reading aperture 10 so that the beam 15 is scanned in a direction transverse to the major axis of the elongate focus. Since the coherent beam 15 is dimensioned at its focus to have a cross-section in the xz plane (plane of the drawing) that is much smaller than a projection of the reading volume in a plane normal to the coherent beam, i.e. in the plane of the housing wall in which the reading aperture is set, a scan of the drive motor 22 will cause the coherent beam 15 to sample many different parts of the reading volume under action of the drive motor 22.

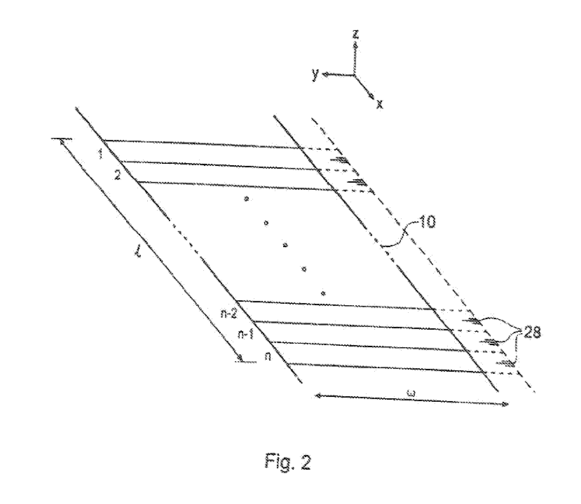

FIG. 2 is included to illustrate this sampling and is a schematic perspective view showing how the reading area is sampled n times by scanning an elongate beam across it. The sampling positions of the focused laser beam as it is scanned along the reading aperture under action of the drive is represented by the adjacent rectangles numbered 1 to n which sample an area of length ‘l’ and width ‘w’. Data collection is made so as to collect signal at each of the n positions as the drive is scanned along the slit. Consequently, a sequence of k×n data points are collected that relate to scatter from the n different illustrated parts of the reading volume.

Also illustrated schematically are optional distance marks 28 formed on the underside of the housing 12 adjacent the slit 10 along the x direction, i.e. the scan direction. An example spacing between the marks in the x-direction is 300 micrometres. These marks are sampled by a tail of the elongate focus and provide for linearisation of the data in the x direction in situations where such linearisation is required, as is described in more detail further below. The measurement is performed by an additional phototransistor 19 which is a directional detector arranged to collect light from the area of the marks 28 adjacent the slit.

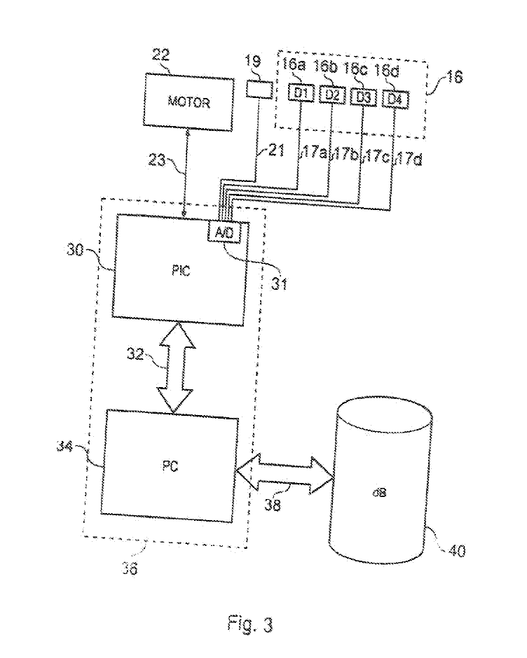

In alternative examples, the marks 28 can be read by a dedicated encoder emitter/detector module 19 that is part of the optics subassembly 20. Encoder emitter/detector modules are used in bar code readers. In one example, an Agilent HEDS-1500 module that is based on a focused light emitting diode (LED) and photodetector can be used. The module signal is fed into the PIC ADC as an extra detector channel (see discussion of FIG. 3 below).

With an example minor dimension of the focus of 40 micrometers, and a scan length in the x direction of 2 cm, n=500, giving 2000 data points with k=4. A typical range of values for k×n depending on desired security level, article type, number of detector channels ‘k’ and other factors is expected to be 100<k×n<10,000. It has also been found that increasing the number of detectors k also improves the insensitivity of the measurements to surface degradation of the article through handling, printing etc. In practice, with the prototypes used to date, a rule of thumb is that the total number of independent data points, i.e. k×n, should be 500 or more to give an acceptably high security level with a wide variety of surfaces. Other minima (either higher or lower) may apply where a scanner is intended for use with only one specific surface type or group of surface types.

FIG. 3 is a block schematic diagram of functional components of the reader apparatus. The motor 22 is connected to a programmable interrupt controller (PIC) 30 through an electrical link 23. The detectors 16a . . . d of the detector module 16 are connected through respective electrical connection lines 17a . . . d to an analogue-to-digital converter (ADC) that is part of the PIC 30. A similar electrical connection line 21 connects the marker reading detector 19 to the PIC 30. It will be understood that optical or wireless links may be used instead of, or in combination with, electrical links. The PIC 30 is interfaced with a personal computer (PC) 34 through a data connection 32. The PC 34 may be a desktop or a laptop. As an alternative to a PC, other intelligent devices may be used, for example a personal digital assistant (PDA) or a dedicated electronics unit. The PIC 30 and PC 34 collectively form a data acquisition and processing module 36 for determining a signature of the article from the set of data points collected by the detectors 16a . . . d.

In some examples, the PC 34 can have access through an interface connection 38 to a database (dB) 40. The database 40 may be resident on the PC 34 in memory, or stored on a drive thereof. Alternatively, the database 40 may be remote from the PC 34 and accessed by wireless communication, for example using mobile telephony services or a wireless local area network (LAN) in combination with the internet Moreover, the database 40 may be stored locally on the PC 34, but periodically downloaded from a remote source. The database may be administered by a remote entity, which entity may provide access to only a part of the total database to the particular PC 34, and/or may limit access the database on the basis of a security policy.

The database 40 can contain a library of previously recorded signatures. The PC 34 can be programmed so that in use it can access the database 40 and performs a comparison to establish whether the database 40 contains a match to the signature of the article that has been placed in the reading volume. The PC 34 can also be programmed to allow a signature to be added to the database if no match is found.

The way in which data flow between the PC and database is handled can be dependent upon the location of the PC and the relationship between the operator of the PC and the operator of the database. For example, if the PC and reader are being used to confirm the authenticity of an article, then the PC will not need to be able to add new articles to the database, and may in fact not directly access the database, but instead provide the signature to the database for comparison. In this arrangement the database may provide an authenticity result to the PC to indicate whether the article is authentic. On the other hand, if the PC and reader are being used to record or validate an item within the database, then the signature can be provided to the database for storage therein, and no comparison may be needed. In this situation a comparison could be performed however, to avoid a single item being entered into the database twice.

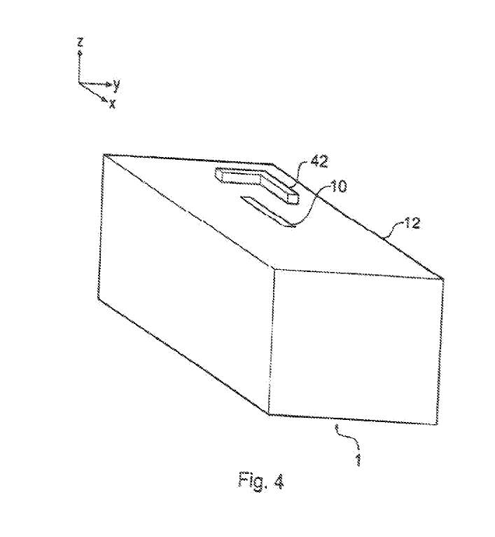

FIG. 4 is a perspective view of the reader apparatus 1 showing its external form. The housing 12 and slit-shaped reading aperture 10 are evident. A physical location aid 42 is also apparent and is provided for positioning an article of a given form in a fixed position in relation to the reading aperture 10. In the present example, the physical location aid 42 is in the form of a right-angle bracket in which the corner of a document or packaging box can be located. This ensures that the same part of the article can be positioned in the reading aperture 10 whenever the article needs to be scanned. A simple angle bracket or equivalent, is sufficient for articles with a well-defined corner, such as sheets of paper, passports, ID cards and packaging boxes. Other shaped position guides could be provided to accept items of different shapes, such as circular items including CDs and DVDs, or items with curved surfaces such as cylindrical packaging containers. Where only one size and shape of item is to be scanned a slot may be provided for receiving the item.

Thus there has now been described an example of a scanning and signature generation apparatus suitable for use in a security mechanism for remote verification of article authenticity. Such a system can be deployed to allow an article to be scanned in more than one location, and for a check to be performed to ensure that the article is the same article in both instances, and optionally for a check to performed to ensure that the article has not been tampered with between initial and subsequent scannings.

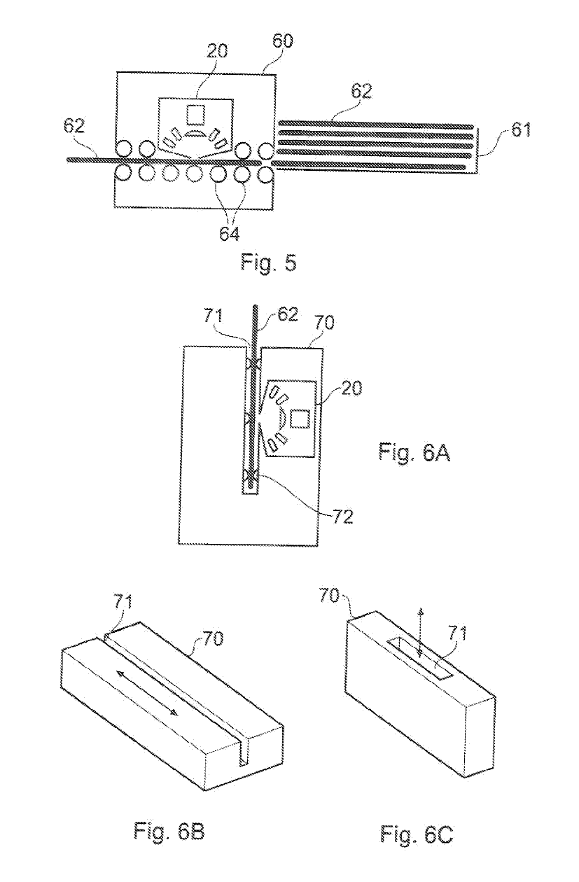

FIG. 5 shows an example of an alternative physical configuration for a reader where a document feeder is provided to ensure that article placement is consistent. In this example, a housing 60 is provided, having an article feed tray 61 attached thereto. The tray 61 can hold one or more articles 62 for scanning by the reader. A motor can drive feed rollers 64 to carry an article 62 through the device and across a scanning aperture of an optics subassembly 20 as described above. Thus the article 62 can be scanned by the optics subassembly 20 in the manner discussed above in a manner whereby the relative motion between optics subassembly and article is created by movement of the article. Using such a system, the motion of the scanned item can be controlled using the motor with sufficient linearity that the use of distance marks and linearisation processing may be unnecessary. The apparatus could follow any conventional format for document scanners, photocopiers or document management systems. Such a scanner may be configured to handle line-feed sheets (where multiple sheets are connected together by, for example, a perforated join) as well as or instead of handing single sheets. For packaging boxes, an alternative would be to provide a suitable guide hole, for example a rectangular cross-section hole for accepting the base of a rectangular box or a circular cross-section hole for accepting the base of a tubular box (i.e. cylindrical box).

Thus there has now been described an apparatus suitable for scanning articles in an automated feeder type device. Depending upon the physical arrangement of the feed arrangement, the scanner may be able to scan one or more of single sheets of material, joined sheets or material or three-dimensional items such as packaging cartons.

FIGS. 6 show examples of further alternative physical configurations for a reader. In this example, the article is moved through the reader by a user. As shown in FIG. 6A, a reader housing 70 can be provided with a slot 71 therein for insertion of an article for scanning. An optics subassembly 20 can be provided with a scanning aperture directed into the slot 71 so as to be able to scan an article 62 passed through the slot. Additionally, guide elements 72 may be provided in the slot 71 to assist in guiding the article to the correct focal distance from the optics sub-assembly 20 and/or to provide for a constant speed passage of the article through the slot.

As shown in FIG. 6B, the reader may be configured to scan the article when moved along a longitudinal slot through the housing 70, as indicated by the arrow. Alternatively, as shown in FIG. 6C, the reader may be configured to scan the article when inserted into or removed from a slot extending into the reader housing 70, as indicated by the arrow. Scanners of this type may be particularly suited to scanning articles which are at least partially rigid, such as card, plastic or metal sheets. Such sheets may, for example, be plastic items such as credit cards or other bank cards.

Thus there have now been described an arrangement for manually initiated scanning of an article. This could be used for scanning bank cards and/or credit cards. Thereby a card could be scanned at a terminal where that card is presented for use, and a signature taken from the card could be compared to a stored signature for the card to check the authenticity and un-tampered nature of the card. Such a device could also be used, for example in the context of reading a military-style metal ID-tag (which tags are often also carried by allergy sufferers to alert others to their allergy). This could enable medical personnel treating a patient to ensure that the patient being treated was in fact the correct bearer of the tag. Likewise, in a casualty situation, a recovered tag could be scanned for authenticity to ensure that a casualty has been correctly identified before informing family and/or colleagues.

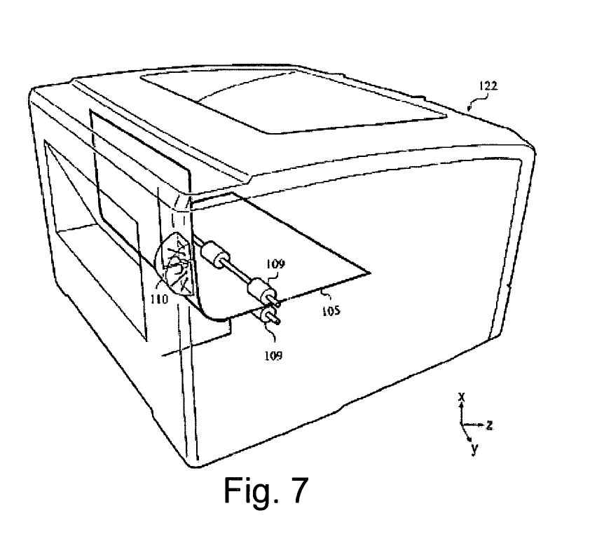

FIG. 7 shows an example of another alternative physical configuration for a reader. In the present example, as shown in FIG. 7 in perspective view, provides a printer 122 with the above-described optics subassembly 20 integrated into it. The printer 122 can be conventional other than the presence of the scan head and associated electronics. To schematically represent the paper feed mechanism the final roller pair 109 thereof is shown. It will be appreciated that the paper feed mechanism includes additional rollers and other mechanical parts. In a prototype example, the scan head is for convenience mounted as illustrated directly after the final roller pair. It will be appreciated that the scan head could be mounted in many different positions along the feed path of the paper. Moreover, although the illustration is of a laser printer, it will be appreciated that any kind of printing device could be used. As well as other forms of printer, such as inkjet printers, thermal printers or dot-matrix printers, the printing device could be any other kind of printing device not conventionally regarded as a printer, such as a networked photocopier machine, or an industrial printing press. For example, the printing device could be a printing press for printing bank notes, cheques, or travellers cheques.

Thus there has now been described an example of an apparatus suitable for printing and scanning of an article. Thereby, the article may be scanned during production so as to avoid the possibility of an article being altered between production and scanning. Thus arrangement may also enable a reduced cost of ownership for such readers, as the increased cost of adding a scanning unit to a printer could easily be lower than the cost of a dedicated scanning device.

The above-described examples are based on localised excitation with a coherent light beam of small cross-section in combination with detectors that accept light signal scattered over a much larger area that includes the local area of excitation. It is possible to design a functionally equivalent optical system which is instead based on directional detectors that collect light only from localised areas in combination with excitation of a much larger area.

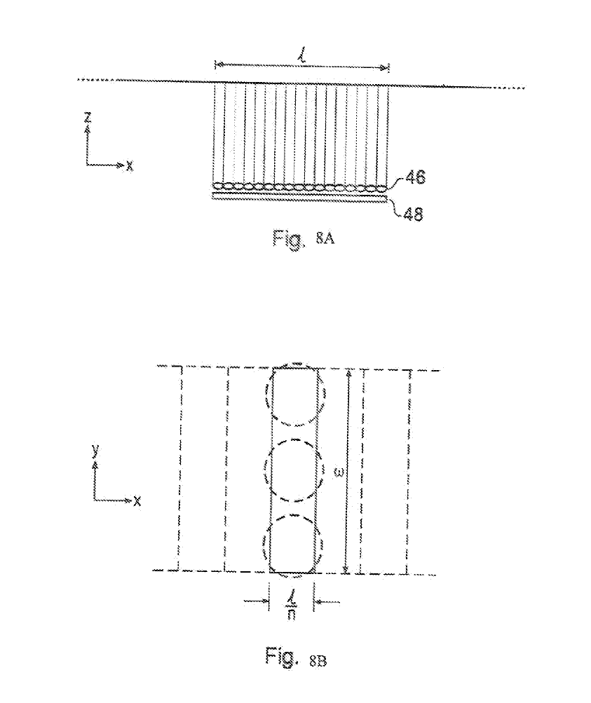

FIG. 8A shows schematically in side view such an imaging arrangement for a reader which is based on directional light collection and blanket illumination with a coherent beam. An array detector 48 is arranged in combination with a cylindrical microlens array 46 so that adjacent strips of the detector array 48 only collect light from corresponding adjacent strips in the reading volume. With reference to FIG. 2, each cylindrical microlens is arranged to collect light signal from one of the n sampling strips. The coherent illumination can then take place with blanket illumination of the whole reading volume (not shown in the illustration).

A hybrid system with a combination of localised excitation and localised detection may also be useful in some cases.

FIG. 8B shows schematically in plan view the optical footprint of such a hybrid imaging arrangement for a reader in which directional detectors are used in combination with localised illumination with an elongate beam. This example may be considered to be a development of the example of FIG. 1 in which directional detectors are provided. In this example three banks of directional detectors are provided, each bank being targeted to collect light from different portions along the ‘I x w’ excitation strip. The collection area from the plane of the reading volume are shown with the dotted circles, so that a first bank of, for example 2, detectors collects light signal from the upper portion of the excitation strip, a second bank of detectors collects light signal from a middle portion of the excitation strip and a third bank of detectors collects light from a lower portion of the excitation strip. Each bank of detectors is shown having a circular collection area of diameter approximately l/m, where m is the number of subdivisions of the excitation strip, where m=3 in the present example. In this way the number of independent data points can be increased by a factor of m for a given scan length l. As described further below, one or more of different banks of directional detectors can be used for a purpose other than collecting light signal that samples a speckle pattern. For example, one of the banks may be used to collect light signal in a way optimised for barcode scanning. If this is the case, it will generally be sufficient for that bank to contain only one detector, since there will be no advantage obtaining cross-correlations when only scanning for contrast.

Having now described the principal structural components and functional components of various reader apparatuses, the numerical processing used to determine a signature will now be described. It will be understood that this numerical processing can be implemented for the most part in a computer program that runs on the PC 34 with some elements subordinated to the PIC 30. In alternative examples, the numerical processing could be performed by a dedicated numerical processing device or devices in hardware or firmware.

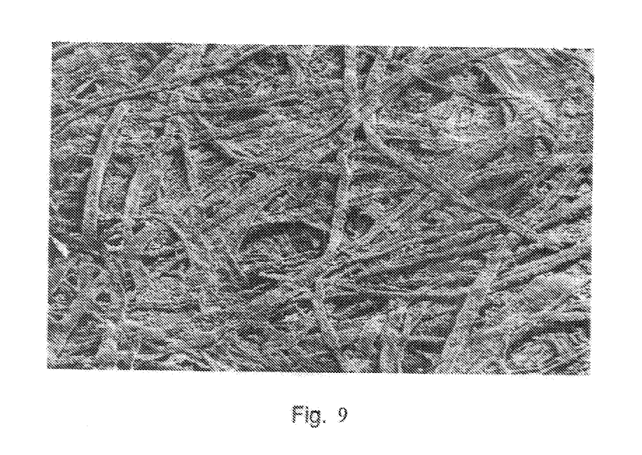

FIG. 9 is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other fibres that make up the paper. The figure is also illustrative of the characteristic length scale for the wood fibres which is around 10 microns. This dimension has the correct relationship to the optical wavelength of the coherent beam of the present example to cause diffraction and hence speckle, and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

In other words, it can be essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

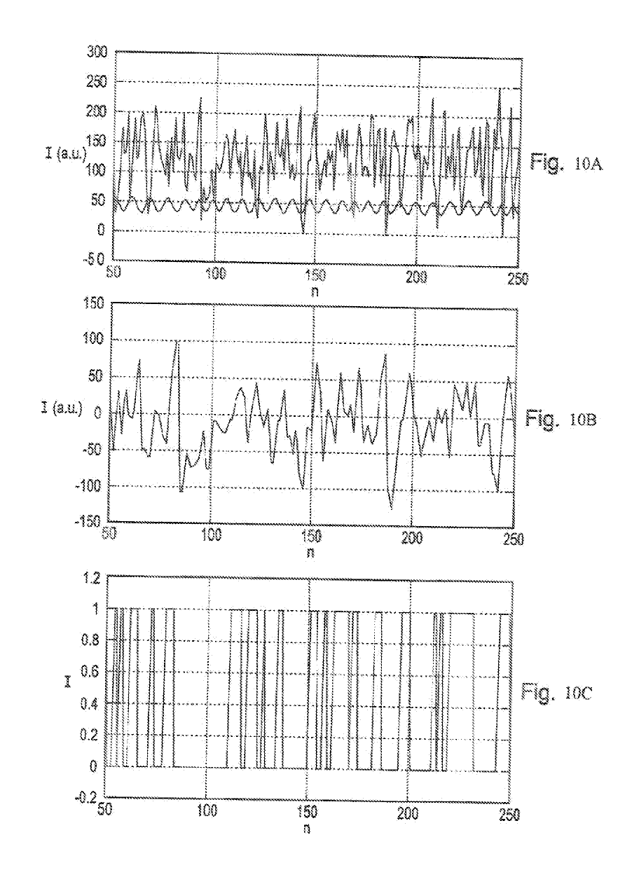

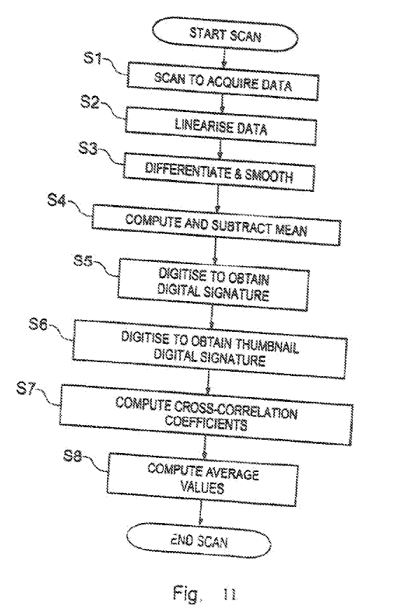

FIG. 10A shows raw data from a single one of the photodetectors 16a . . . d of the reader of FIG. 1. The graph plots signal intensity I in arbitrary units (a.u.) against point number n (see FIG. 2). The higher trace fluctuating between I=0-250 is the raw signal data from photodetector 16a. The lower trace is the encoder signal picked up from the markers 28 (see FIG. 2) which is at around I=50.

FIG. 10B shows the photodetector data of FIG. 10A after linearisation with the encoder signal (n.b. although the x axis is on a different scale from FIG. 10A, this is of no significance). As noted above, where a movement of the article relative to the scanner is sufficiently linear, there may be no need to make use of a linearisation relative to alignment marks. In addition, the average of the intensity has been computed and subtracted from the intensity values. The processed data values thus fluctuate above and below zero.

FIG. 10C shows the data of FIG. 10B after digitisation. The digitisation scheme adopted is a simple binary one in which any positive intensity values are set at value 1 and any negative intensity values are set at zero. It will be appreciated that multi-state digitisation could be used instead, or any one of many other possible digitisation approaches. The main important feature of the digitisation is merely that the same digitisation scheme is applied consistently.

FIG. 11 is a flow diagram showing how a signature of an article is generated from a scan.

Step S1 is a data acquisition step during which the optical intensity at each of the photodetectors is acquired approximately every 1 ms during the entire length of scan. Simultaneously, the encoder signal is acquired as a function of time. It is noted that if the scan motor has a high degree of linearisation accuracy (e.g. as would a stepper motor) then linearisation of the data may not be required. The data is acquired by the PIC 30 taking data from the ADC 31. The data points are transferred in real time from the PIC 30 to the PC 34. Alternatively, the data points could be stored in memory in the PIC 30 and then passed to the PC 34 at the end of a scan. The number n of data points per detector channel collected in each scan is defined as N in the following. Further, the value aₖ(i) is defined as the i-th stored intensity value from photodetector k, where i runs from 1 to N. Examples of two raw data sets obtained from such a scan are illustrated in FIG. 8A.

Step S2 uses numerical interpolation to locally expand and contract aₖ(i) so that the encoder transitions are evenly spaced in time. This corrects for local variations in the motor speed. This step can be performed in the PC 34 by a computer program.

Step S3 is an optional step. If performed, this step numerically differentiates the data with respect to time. It may also be desirable to apply a weak smoothing function to the data. Differentiation may be useful for highly structured surfaces, as it serves to attenuate uncorrelated contributions from the signal relative to correlated (speckle) contributions.

Step S4 is a step in which, for each photodetector, the mean of the recorded signal is taken over the N data points. For each photodetector, this mean value is subtracted from all of the data points so that the data are distributed about zero intensity. Reference is made to FIG. 10B which shows an example of a scan data set after linearisation and subtraction of a computed average.

Step S5 digitises the analogue photodetector data to compute a digital signature representative of the scan. The digital signature is obtained by applying the rule: aₖ(i)>0 maps onto binary ‘1’ and aₖ(i)<=0 maps onto binary ‘0’. The digitised data set is defined as dₖ(i) where i runs from 1 to N. The signature of the article may incorporate further components in addition to the digitised signature of the intensity data just described. These further optional signature components are now described.

Step S6 is an optional step in which a smaller ‘thumbnail’ digital signature is created. This is done either by averaging together adjacent groups of m readings, or more preferably by picking every cth data point, where c is the compression factor of the thumbnail. The latter is preferred since averaging may disproportionately amplify noise. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients are useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and a₁(i), where k≠1 and k,1 vary across all of the photodetector channel numbers. The normalised cross-correlation function Γ is defined as

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background.

The signature data obtained from scanning an article can be compared against records held in a signature database for verification purposes and/or written to the database to add a new record of the signature to extend the existing database.

A new database record will include the digital signature obtained in Step S5. This can optionally be supplemented by one or more of its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

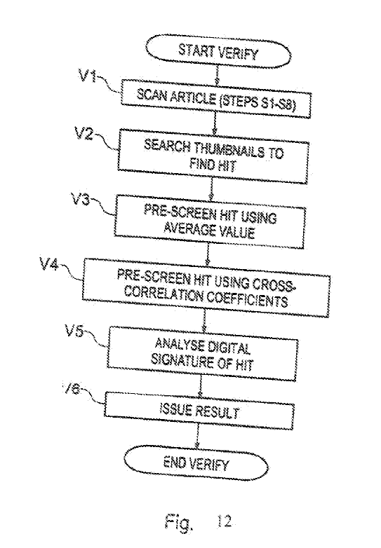

FIG. 12 is a flow diagram showing how a signature of an article obtained from a scan can be verified against a signature database.

In a simple implementation, the database could simply be searched to find a match based on the full set of signature data. However, to speed up the verification process, the process can use the smaller thumbnails and pre-screening based on the computed average values and cross-correlation coefficients as now described.

Verification Step V1 is the first step of the verification process, which is to scan an article according to the process described above, i.e. to perform Scan Steps S1 to S8.

Verification Step V2 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-corrleation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. A typical value for q is 4 and a typical value for k is 4, making typically 16 bits per block. The qk bits are then matched against the qk corresponding bits in the stored digital signature dₖ^{db} (i+j). If the number of matching bits within the block is greater or equal to some pre-defined threshold zₜₕᵣₑₛₕ, then the number of matching blocks is incremented. A typical value for zₜₕᵣₑₛₕ is 13. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of z_{threshold}), M is the number of matching blocks and p(M) is the probability of M or more blocks matching accidentally. The value of s is determined by comparing blocks within the data base from scans of different objects of similar materials, e.g. a number of scans of paper documents etc. For the case of q=4, k=4 and z_{threshold}=13, we typical value of s is 0.1. If the qk bits were entirely independent, then probability theory would give s=0.01 for z_{threshold}=13. The fact that a higher value is found empirically is because of correlations between the k detector channels and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

Thus there have now been described a number of examples arrangements for scanning an article to obtain a signature based upon intrinsic properties of that article. There have also been described examples of how that signature can be generated from the data collected during the scan, and how the signature can be compared to a later scan from the same or a different article to provide a measure of how likely it is that the same article has been scanned in the later scan.

Such a system has many applications, amongst which are security and confidence screening of items for fraud prevention and item traceability.

In e-commerce systems and similar systems, a document or entitlement token indicating entitlement to value, goods or services can be issued at a time and/or location which is remote from an access point to the value, goods or services. To provide security against fraud and other interruptions in the successful operation of such systems, the document or entitlement token can be independently validated to ensure that a claimer of the entitlement is in fact so entitled.

Suitable systems for effecting this security provision will be described in the following examples, making reference to various real-world applications in which the security provision can be applied.

One example, is where a person uses an on-line shopping facility to purchase a ticket for access to an event or for travel. In this example, the user can be provided with an image of the ticket to his access terminal. The user can then print the ticket using a printer associated with the access terminal for use in accessing the event or for travelling. The user can then cause the ticket to be scanned to create a signature to identify the ticket, which signature is returned to the ticket issuer in order to validate the ticket. The signature can be based upon an intrinsic property of the printed ticket, which cannot be duplicated by photographic duplication of the ticket or by printing a further copy of the ticket. The ticket issuer can store the signature in a signature database of validated ticket signatures. When the user presents the ticket to obtain access to the event or to travel, the ticket can be scanned to create a signature to identify the ticket. This new signature can then be compared to the signatures in the database to determine whether the presented ticket has been validated. In the event of a non-validated ticket being presented, access to the event or to travel can be withheld.

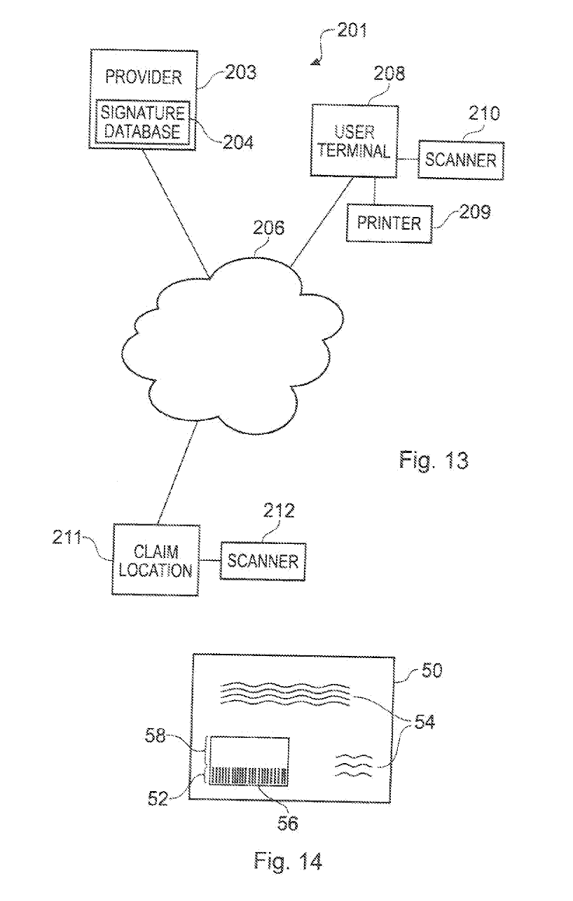

This process is illustrated in FIG. 13. As shown in FIG. 13, an e-commerce environment 201, includes a provider 203, which has authority to issue a ticket for access to an event (such as a sports match or concert), or for travel (for example by railway train). By communicating with the provider 203 via a network 206 such as the Internet, a user at a user terminal 208 can purchase a ticket from the provider 203. This purchase mechanism can be any conventional system for allowing a remote user to purchase goods or services through a shopping or ordering portal. Such online remote ordering systems are used by many businesses, charities and governments. The process of purchasing the ticket can, for example, be performed using an online shopping basket system where a user views one or more tickets which he can select for purchase. In the context of an event ticket, different ones of the tickets may offer access to different events, or to different viewing locations at the event. In the context of a ticket for travel, different tickets may be offered for a given journey, depending upon route used and quality/class of travel.

In response to the ticket purchase, the provider 203 sends a ticket image data file to the user terminal 208, for output on a printer 209 associated with the terminal. The ticket may be printed onto a special ticket printing sheet (such as a paper or card sheet preconfigured to have certain ticket information printed at predetermined printing locations thereon) or may be a conventional printing sheet such as a sheet of plain paper. The printed ticket is then scanned by scanner 210, to create a signature based on an intrinsic property of the printed ticket. The scanner 210 can be a scanner as describe above with reference to any of FIGS. 1 to 8. In one example, the scanner 210 is integral with the printer 209 as described with reference to FIG. 7 above. Thus in the present example, the signature is based upon the physical surface of the sheet onto which the signature is printed, measured at a microscopic level. This signature is thus unique to that printed ticket, and another printed copy of the ticket would have a different signature if scanned in the same way.

The signature is then sent from the user terminal 208 to the provider 203, where it is stored in a signature database 204. Thereby the printed ticket is validated and can be recognised as a valid ticket by the provider.

When the user attends the event for which the ticket is issued, or uses the ticket for travel, he can present the printed ticket at a claim location 211. The claim location can be co-located with the service provider, or may be remote therefrom. For example, one service provider may sell tickets to a number of events, each of which events may take place at a different location. Alternatively, in the case of tickets for travel, one provider may issue tickets for travel to or from a number of different locations. Upon presentation of the printed ticket at the claim location 211, the printed ticket can be scanned using a scanner 212 to create a signature for the printed ticket as presented. This signature is generated in the same way and using the same property of the ticket as the signature created using scanner 210. This new signature is then compared to the signatures stored in the signature database 204. If the new signature matches one of the stored signatures, which will be the case if the printed ticket has been validated as described above, then a positive authentication result is returned. The user can then be provided with access to the event or to the travel to which the printed ticket provides entitlement.

As the printed ticket is authenticated against a single printed instance of the ticket image, further copies of the ticket image will fail the validation test as they will have been printed onto a sheet having a different intrinsic property to that of the sheet of the validated printed ticket. Thereby, fraud on the part of the user to create extra tickets to obtain event access or travel without payment can be prevented.

Thus there has now been described an example of a system for allowing an entitlement token such as a ticket to be generated at a location convenient for a purchaser of the entitlement token, and for the issuer of the entitlement token to be able to validate the token for later authentication when the entitlement token is presented for access to value, goods or services. Thereby fraudulent reproduction or reuse of an entitlement token can be prevented without subjecting the purchaser to a need to travel to an inconvenient location to obtain the token.

Another example of a remote purchase system allows a user to purchase tickets for air travel. As is well known, the air travel industry typically uses a two-stage ticketing process. The first stage in the process is the actual ticket, which entitles the user to fly on a given journey or journeys. The second stage is the boarding pass, which is typically provided to a traveller (often in exchange for the ticket) when that traveller “checks-in” for a journey. Some ticketing authorities and airlines are now issuing so-called “e-tickets”. This consists of a data file transferred, typically via email, to the purchaser of a ticket. The purchaser can then print out the ticket for presentation for “check-in” at an airport. In some instances, only the reference number from the e-ticket is required for “check-in”, the physical printout merely representing a convenient carrier medium for the reference number.

Also, some airlines and airports now permit remote check-in. In these circumstances, a ticket holder can check-in, usually using an internet portal, before arrival at an airport. Thereby standing in check-in queues at the airport can be avoided. In such cases, the ticket may be a physical “paper” ticket or an e-ticket. In this scheme, the ticket holder prints out the boarding pass using a printer associated with a computer terminal used to access the internet check-in portal. A physical security check can be performed upon arrival of the ticket holder at the airport, by requiring the ticket holder to present their ticket or reference number in addition to the self-printed boarding pass. However, such checks are often not performed until a passenger reaches a boarding gate for an aircraft. Thus a holder of a fraudulently produced boarding pass may be able to access areas of an airport reserved for departing travellers only. This may include access to, for example, shopping facilities where sales tax or value added tax is not applied, thus enabling the bearer of such a boarding pass to commit a tax fraud.

Thus, in the present example, a user can access a remote check-in portal and exchange either value (for example by transfer from a bank account or credit card account—effectively cutting out the ticketing stage) or entitlement (for example a ticket reference number) for a boarding pass. Once the necessary purchase or exchange processes have been completed between the prospective traveller at the computer terminal from which the remote check-in portal is accessed and the ticketing/check-in authority at a remote online business server, the ticketing/check-in authority can electronically transmit a boarding card image or data template to the computer terminal. This can be done as a direct data transfer, for example using http, shttp, https, or ftp, or by indirect data transfer, such as by email. Once the boarding card image is received by the prospective traveller, he can print off the boarding card for use in travel.

In the present example, the printed boarding card is then scanned to determine a signature therefor. This can be performed as part of the printing process, for example using an apparatus as discussed with reference to FIG. 7 above, or after the printing process using a separate scanner. The signature can then be uploaded to the ticketing/check-in authority or to any other certification authority which the ticketing/check-in authority might wish to use in order to validate the printed boarding pass.

Subsequently, when the prospective traveller arrives at the airport from which his journey is to start, he can be required to present his boarding pass to gain access to the flight, and optionally to one or more areas reserved for access only to travellers. Upon presentation of the boarding pass, it can be scanned to create a new signature. This new signature can then be submitted to the certification authority where the validation signature was stored. The certification authority can then compare the new signature to the database using one or more of the techniques referred to above, especially with reference to FIG. 12, to determine whether the presented boarding pass is the original boarding pass which was printed. A positive authentication result can indicate that the prospective traveller should be granted access to the aircraft. A negative authentication result can indicate that the prospective traveller should not be granted access to the aircraft, and optionally a law enforcement agency or similar can be contacted to address the attempted unauthorised passage through a security cordon.

Thus there have now been described a number of examples of systems which can use a signature for an article which is based upon an intrinsic property of that article to provide further security and/or confidence to a transaction system where remote access is provided to confidential information or to an ordering system, or for tracking or authentication of entitlement tokens.

Although the above examples have been described in the context of the coherent light based signature generation scheme described in detail above, the systems can also be implemented using, for example a signature generation scheme based upon, for example, analysis of magnetic field of an article.

Although the above examples have been described in the context of printing an entitlement token onto paper, the token could be printed onto an alternative substrate, such as cardboard, plastic or metal. Alternatively, the token could be “printed” in the form of writing token data to a magnetic strip or embedded chip of a plastic card, such as the plastic cards commonly used for bank cards and credit cards. This could be performed using a scanner such as those discussed with reference to FIGS. 6B and 6C above, which scanner could optionally be additionally equipped with a writing head such that the writing and scanning could take place simultaneously in the same device. The plastic card could be scanned, optionally including at least a surface portion including the magnetic strip or embedded chip, to create the signature for validation of that entitlement. In this way, one physical card could hold more than one entitlement token. The card could then be rescanned when presented to redeem an entitlement, and the signature created at the rescanning could be used to verify that the card from which the entitlement was claimed was the same card as that to which the entitlement was originally written. A database of entitlements could be updated each time that an entitlement is added to the card or used from the card, such that the database can have a record of entitlements active on the card at any given time.

With reference to FIG. 14 there will now be described an example of an alternative method for storing the scanned validation signature for later authentication. In this example, the storage is performed by writing an encoded form of the signature onto the token itself.

FIG. 14 shows an electronic ticket 50 bearing a barcode as well as written printed information 54. The barcode is shown as part of a scan area 56. This is illustrated with a dashed line, since it is featureless on the electronic ticket. The scan area is subdivided between a lower area 52 containing the barcode and a blank upper area 58. The electronic ticket 50 is designed to be scanned by a reader apparatus of the kind described above. In this example, the barcode encodes the signature obtained by scanning the blank upper area.

In other words, the barcode was originally applied at the time of creation of the electronic ticket, e.g. by an online purchaser using their local printer by scanning the blank upper area of the ticket and then printing the barcode onto the lower area 52. The electronic ticket is thus labelled with a signature characteristic of its intrinsic structure, namely the surface structure in the upper area 58.

It will be appreciated that this basic approach can be used to mark a wide variety of articles with a label that encodes the articles own signature obtained from its intrinsic physical properties, for example any printable article, including paper or cardboard articles or plastic articles.

Given the public nature of the barcode or other label that follows a publicly known encoding protocol, it is advisable to make sure that the signature has been transformed using an asymmetric encryption algorithm for creation of the barcode, i.e. a one-way function is used, such as according to the well known RSA algorithm. A preferred implementation is for the label to represent a public key in a public key/private key encryption system. Typically the system will be used by a large number of different customers, and it may be advisable that at least each customer, perhaps each ticket, has its own private key, so that disclosure of a private key will only affect one customer or ticket. The label thus encodes the public key and the private key is located securely with the issuer entity or other authorised parties (e.g. the vendor or the vendor's ticketing agent).

As will be appreciated, the number and distribution of key pairs can be determined according to a desired security performance. For example a ticket issuing entity require a single private/public key pair for all tickets, for all tickets for a given event, for all tickets issues through a given ticketing authority, for all tickets issued to a particular customer, for every ticket, or for any combination of these possibilities. Thus disclosure of a single private key may affect the security of the system to varying degrees, in dependence upon the number and use patterns of key pairs.

Alternatively, the encryption could be symmetric. In this case the key could be held securely in tamper-proof memory or crypto-processor smart cards on the document scanners.

The labelling scheme could be used to allow articles to be verified without access to a database purely on the basis of the label.

However, it is also envisaged that the labelling scheme could be used in combination with a database verification scheme. For example, the barcode could encode a thumbnail form of the digital signature and be used to allow a rapid pre-screen prior to screening with reference to a database. This could be a very important approach in practice, since potentially in some database applications, the number of records could become huge (e.g. millions) and searching strategies would become critical. Intrinsically high speed searching techniques, such as the use of bitstrings, could become important.

As an alternative to the barcode encoding a thumbnail, the barcode (or other label) could encode a record locator, i.e. be an index or bookmark, which can be used to rapidly find the correct signature in the database for further comparison.

Another variant is that the barcode (or other label) encodes a thumbnail signature which can be used to get a match with reasonable but not high confidence if a database is not available (e.g. temporarily off-line, or the scanning is being done in an unusually remote location without internet access). That same thumbnail can then be used for rapid record locating within the main database if the database is available, allowing a higher confidence verification to be performed.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

1. A method for authenticity verification, the method comprising:
conducting a transaction between first and second parties, the parties being respectively located at first and second locations remote one-another, the outcome of the transaction being the provision by the first party to the second party of the right to an entitlement token;
transmitting data describing a written format for the entitlement token from the first party to the second party;
writing the entitlement token using the data describing the written format at the second location;
creating a first signature for the written entitlement token at the second location, the first signature being created by directing a coherent beam onto the written entitlement token, collecting a set comprising groups of data points from signals obtained when the coherent beam scatters from the written entitlement token, wherein different ones of the groups of data points relate to scatter from respective different parts of the written entitlement token, and processing the set of groups of data points;
transmitting the first signature to the first party; and
retaining the first signature or an attribute thereof for subsequent authenticity verification of the written entitlement token.

2. The method of claim 1, wherein the retaining step comprises storing the first signature in a signature database for subsequent authenticity verification.

3. The method of claim 1, wherein the retaining step comprises the first party processing the first signature to generate labelling data that encodes the first signature according to a machine-readable encoding protocol, transmitting the labelling data to the second party, and writing a label representing the labelling data at the second location onto the entitlement token.

4. The method of claim 3, wherein the first signature is encoded in the label using an asymmetric encryption algorithm.

5. The method of claim 4, wherein the label represents a public key in a public key/private key encryption system.

6. The method of claim 3, wherein the label is an ink label applied with a printing process.

7. The method of claim 1, further comprising:
creating a second signature for the written entitlement token at a third location remote from the second location, the second signature being created by directing a coherent beam onto the written entitlement token, collecting a set comprising groups of data points from signals obtained when the coherent beam scatters from the written entitlement token, wherein different ones of the groups of data points relate to scatter from respective different parts of the written entitlement token, and processing the set of groups of data points; and
comparing attributes of the second signature with attributes of the first signature to verify the authenticity of the written entitlement token.

8. The method of claim 1, wherein, in the event that the comparison step indicates substantial identity between attributes of the first and second signatures, a positive comparison result is returned.

9. The method of claim 1, further comprising creating said first signature using an apparatus integral with an apparatus for writing the entitlement token.

10. The method of claim 1, wherein the step of writing the entitlement token comprises printing the data describing the token onto a printing sheet.

11. The method of claim 10, wherein the printing sheet is selected from a paper sheet, a cardboard sheet, a plastic sheet and a metal sheet.

12. The method of claim 10, wherein the printing sheet has a pattern thereon prior to printing the data thereonto.

13. The method of claim 1, wherein the step of writing the entitlement token comprises writing data describing the entitlement onto a data storage device.

14. The method of claim 13, wherein the data storage device is selected from a magnetic storage device or an electronic storage device physically associated with a plastic or metal card.

15. The method of claim 1, wherein the token indicates an entitlement to goods or services.

16. The method of claim 15, wherein entitlement to the goods or services is dependent upon a positive verification of authenticity of the written entitlement token.

17. The method of claim 1, wherein the entitlement token is selected from the group consisting of a ticket, a value transfer document, and an access pass.

18. The method of claim 1, wherein the first location comprises an e-commerce server.

19. The method of claim 1, wherein the second location comprises a computer terminal.

20. The method of claim 1, wherein the third location comprises a computer terminal.

21. The method of claim 1, wherein the third location is situated at a redemption location for the written entitlement token.

22. A system for authenticity verification, the system comprising:
first and second computer systems remote one-another and operable to communicate therebetween via a data communications channel, wherein the first computer system is operable to enable to user at the second computer system to conduct a transaction with the first computer system, the outcome of the transaction being the provision by the first computer system to the user of the right to an entitlement token, wherein the first computer system is further operable to transmit data describing the entitlement token to the second computer system via the data communications channel;
a writer co-located with the second computer system and operable to write the entitlement token using the data describing the token; and
a first signature generator co-located with the second computer system and operable to create a first signature for the written entitlement token, the signature generator operable to create the signature by directing a coherent beam onto the written entitlement token, collecting a set comprising groups of data points from signals obtained when the coherent beam scatters from the written entitlement token, wherein different ones of the groups of data points relate to scatter from respective different parts of the written entitlement token, and processing the set of groups of data points, and to transmit the first signature to the first party.

23. The system of claim 22, further comprising:
a signature database operable to store the first signature for subsequent authenticity verification.

24. The system of claim 22, wherein the first computer system is operable to process the first signature to generate labelling data that encodes the first signature according to a machine-readable encoding protocol, and to transmit the labelling data to the second party, and wherein the writer is operable to write a label encoding the labelling data onto the entitlement token.

25. The system of claim 24, wherein the first signature is encoded in the label using an asymmetric encryption algorithm.

26. The system of claim 25, wherein the label represents a public key in a public key/private key encryption system.

27. The system of claim 24, wherein the writer is operable to print the label as an ink label onto the written entitlement token.

28. The system of claim 26, further comprising:
a second signature generator co-located with a third computer system remote from the second computer system operable to create a second signature for the written entitlement token, the signature generator operable to create the signature by directing a coherent beam onto the written entitlement token, collecting a set comprising groups of data points from signals obtained when the coherent beam scatters from the written entitlement token, wherein different ones of the groups of data points relate to scatter from respective different parts of the written entitlement token, and processing the set of groups of data; and
a comparator operable to compare attributes of the second signature with attributes of the first signature to verify the authenticity of the written entitlement token.

29. The system of claim 28, further comprising a focusing arrangement for bringing the coherent beam into focus in the reading volume.

30. The system of claim 29, wherein the focusing arrangement is configured to bring the coherent beam to an elongate focus, and wherein the drive is configured to move the coherent beam over the reading volume in a direction transverse to the major axis of the elongate focus.

31. The system of claim 28, wherein it is ensured that different ones of the data points relate to scatter from different parts of the reading volume, in that the detector arrangement includes a plurality of detector channels arranged and configured to sense scatter from respective different parts of the reading volume.

32. The system of claim 28, further comprising a housing for accommodating at least a part of the detector arrangement and having a reading aperture against or into which a written entitlement token is placeable so that it is positioned in the reading volume.

33. The system of claim 28, further comprising a written entitlement token conveyor for moving an article past the coherent beam.

34. The system of claim 28, comprising a physical location aid for positioning a written entitlement token of a given form in a fixed position in relation to the reading volume.

35. The system of claim 28, wherein the detector arrangement consists of a single detector channel.

36. The system claim 28, wherein the detector arrangement comprises a group of detector elements angularly distributed and operable to collect a group of data points for each different part of the reading volume.

37. The system of claim 28, wherein the source is mounted to direct the coherent beam onto the reading volume so that it will strike a written entitlement token with near normal incidence.

38. The system of claim 28, wherein the detector arrangement is arranged in reflection to detect radiation back scattered from the reading volume.

39. The system claim 28, wherein the data acquisition and processing module is operable to further analyse the data points to identify a signal component that follows a predetermined encoding protocol and to generate a reference signature therefrom.

40. The system of claim 22, wherein the writer is co-located with the first signature generator.

41. The system of claim 22, wherein the written entitlement token comprises a printed pattern on a printing substrate or printing sheet.

42. The system of claim 41, wherein the printing sheet is selected from the group consisting of a paper sheet, a cardboard sheet, a plastic sheet and a metal sheet.

43. The system of claim 41, wherein the printing sheet has a pattern thereon prior to printing the data thereonto.

44. The system of claim 41, wherein the printing substrate is a selected from the group comprising a packaging container and a manufactured article.

45. The system of claim 22, wherein the written entitlement token comprises a data storage device.

46. The system of claim 45, wherein the data storage device is selected from a magnetic storage device and an electronic storage device physically associated with a plastic or metal card.

47. The system of claim 22, wherein the written entitlement token indicates an entitlement to goods or services.

48. The system of claim 47, wherein the entitlement to the goods or services is dependent upon a positive verification of authenticity of the written entitlement token.

49. The system of claim 22, wherein the entitlement token is selected from the group consisting of a ticket, a value transfer document, and an access pass.

50. The system of claim 22, wherein the third location is a redemption location for the written entitlement token.

51. Use of the system of claim 22 in order to verify authenticity of a written entitlement token.

52. Use of the system of claim 22 in order to ascertain whether a written entitlement token has been tampered with.

53. A method for authenticating a ticket, the method comprising:
creating a ticket at a location remote from an issue entity therefor;
scanning the ticket at the creation location to create a first signature therefor by directing a coherent beam onto the ticket, collecting a set comprising groups of data points from signals obtained when the coherent beam scatters from the ticket, wherein different ones of the groups of data points relate to scatter from respective different parts of the ticket, and processing the set of groups of data points;
transmitting the first signature to the issue entity and retaining the first signature or an attribute thereof for subsequent ticket verification;
in response to presentation of the ticket for redemption, scanning the ticket to create a second signature therefor by directing a coherent beam onto the ticket, collecting a set comprising groups of data points from signals obtained when the coherent beam scatters from the ticket, wherein different ones of the groups of data points relate to scatter from respective different parts of the ticket, and processing the set of groups of data points; and
comparing attributes of the first and second signatures to determine a validity confidence for the ticket.

54. The method of claim 53, wherein the first signature or an attribute thereof is stored in a database for the subsequent ticket verification in which an attribute of the first signature is retrieved for comparison by reference to the database.

55. The method of claim 53, wherein the first signature or an attribute thereof is used by the issue entity to create labelling data that encodes the first signature according to a machine-readable encoding protocol, and the labelling data is transmitted to the second party, and written at the second location onto the entitlement token as a label for the subsequent ticket verification in which an attribute of the first signature is retrieved for comparison by reference to the label.

56. A method for authenticating an access permit, the method comprising:
creating a access permit at a location remote from an issue entity therefor;
scanning the access permit at the creation location to create a first signature therefor by directing a coherent beam onto the access permit, collecting a set comprising groups of data points from signals obtained when the coherent beam scatters from the access permit, wherein different ones of the groups of data points relate to scatter from respective different parts of the access permit, and processing the set of groups of data points;
transmitting the first signature to the issue entity and retaining the first signature or an attribute thereof for subsequent access permit verification;
in response to presentation of the access permit for redemption, scanning the access permit to create a second signature therefor by directing a coherent beam onto the access permit, collecting a set comprising groups of data points from signals obtained when the coherent beam scatters from the access permit, wherein different ones of the groups of data points relate to scatter from respective different parts of the access permit, and processing the set of groups of data points; and
comparing attributes of the first and second signatures to determine a validity confidence for the access permit.

57. The method of claim 56, wherein the first signature or an attribute thereof is stored in a database for the subsequent access permit verification in which an attribute of the first signature is retrieved for comparison by reference to the database.

58. The method of claim 56, wherein the first signature or an attribute thereof is used by the issue entity to create labelling data that encodes the first signature according to a machine-readable encoding protocol, and the labelling data is transmitted to the second party, and written at the second location onto the entitlement token as a label for the subsequent access permit verification in which an attribute of the first signature is retrieved for comparison by reference to the label.
